(19) United States
(12) Patent Application Publication
(10) Pub. No.: US 2024/0012343 A1
(43) Pub. Date: Jan. 11, 2024

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Kota Maki, Kanagawa (JP); Masahiro Iwasaki, Kanagawa (JP)

(73) Assignee: FUJIFILM Business Innovation Corp., Tokyo (JP)

(21) Appl. No.: 18/189,219

(22) Filed: Mar. 24, 2023

(30) Foreign Application Priority Data
Jul. 8, 2022 (JP) 2022-110795

(51) Int. Cl. G03G 5/06; G03G 21/18

(52) U.S. Cl. CPC G03G 5/0659; G03G 21/1803; G03G 2221/183

(57) ABSTRACT

An electrophotographic photoreceptor includes a conductive substrate, an undercoat layer disposed on the conductive substrate, and a photosensitive layer disposed on the undercoat layer, in which the undercoat layer contains an organic pigment and a binder resin and satisfies Expressions (A1) and (B1),

εr(Max)≤7.0 Expression (A1)

tan δ(Max)≤0.5 Expression (B1)
εr (Max) represents a maximum value of a relative permittivity at a measurement frequency of 10 Hz to 3,000 Hz and tan δ(Max) represents a maximum value of a dielectric loss tangent at the measurement frequency of 10 Hz to 3,000 Hz, which are acquired by measuring an impedance of the undercoat layer at a temperature of 22° C. and a relative humidity of 50%.

### CROSS-REFERENCE TO RELATED APPLICATIONS

This application is based on and claims priority under 35 USC 119 from Japanese Patent Application No. 2022-110795 filed Jul. 8, 2022.

### BACKGROUND

### (i) Technical Field

The present invention relates to an electrophotographic photoreceptor, a process cartridge, and an image forming apparatus.

### (ii) Related Art

JP2020-046640A discloses an electrophotographic photoreceptor that includes a conductive substrate, an undercoat layer, and a photosensitive layer, in which the undercoat layer contains a perinone compound and polyurethane.

JP2020-154129A discloses an electrophotographic photoreceptor that includes a conductive substrate, an undercoat layer, and a photosensitive layer, in which the undercoat layer contains a perinone compound, at least one kind of metal oxide particles selected from the group consisting of oxide aluminum particles, iron oxide particles, copper oxide particles, magnesium oxide particles, calcium oxide particles, and silicon dioxide particles, and a binder resin, and the undercoat layer has a thickness of 1 μm or greater and 10 μm or less.

### SUMMARY

Aspects of non-limiting embodiments of the present disclosure relate to an electrophotographic photoreceptor in which spot-like image defects are less likely to occur as compared with an electrophotographic photoreceptor including an undercoat layer that does not satisfy Expressions (A1) and (B1).

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object includes the following aspect.

According to an aspect of the present disclosure, there is provided an electrophotographic photoreceptor including: a conductive substrate; an undercoat layer disposed on the conductive substrate; and a photosensitive layer disposed on the undercoat layer, in which the undercoat layer contains an organic pigment and a binder resin and satisfies Expressions (A1) and (B1),

εr(Max)≤7.0 Expression (A1)

tan δ(Max)≤0.5 Expression (B1)
εr (Max) represents a maximum value of a relative permittivity at a measurement frequency of 10 Hz to 3,000 Hz and tan δ(Max) represents a maximum value of a dielectric loss tangent at the measurement frequency of 10 Hz to 3,000 Hz, which are acquired by measuring an impedance of the undercoat layer at a temperature of 22° C. and a relative humidity of 50%.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to the present exemplary embodiment;

FIG. 2 is a partial cross-sectional view showing another example of a layer configuration of an electrophotographic photoreceptor according to the present exemplary embodiment;

FIG. 3 is a schematic configuration view showing an example of an image forming apparatus according to the present exemplary embodiment;

FIG. 4 is a schematic configuration view showing another example of an image forming apparatus according to the present exemplary embodiment; and

FIG. 5 is a schematic view showing an image formed for evaluating the image quality in an example.

### DETAILED DESCRIPTION

Hereinafter, exemplary embodiments of the present disclosure will be described. The following descriptions and examples merely illustrate the exemplary embodiments, and do not limit the scope of the exemplary embodiments.

In the present disclosure, a numerical range shown using “to” indicates a range including numerical values described before and after “to” as a minimum value and a maximum value.

In a numerical range described in a stepwise manner in the present disclosure, an upper limit value or a lower limit value described in a certain numerical range may be replaced with an upper limit value or a lower limit value in another numerical range described in a stepwise manner. Further, in a numerical range described in the present disclosure, an upper limit value or a lower limit value described in the numerical range may be replaced with a value shown in Examples.

In the present disclosure, the meaning of the term “step” includes not only an independent step but also a step whose intended purpose is achieved even in a case where the step is not clearly distinguished from other steps.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of kinds of substances corresponding to each component. In the present disclosure, in a case where a plurality of kinds of substances corresponding to each component in a composition are present, the amount of each component in the composition indicates the total amount of the plurality of kinds of substances present in the composition unless otherwise specified.

In the present disclosure, each component may include a plurality of kinds of particles corresponding to each component. In a case where a plurality of kinds of particles corresponding to each component are present in a composition, the particle diameter of each component indicates the value of a mixture of the plurality of kinds of particles present in the composition, unless otherwise specified.

Electrophotographic Photoreceptor

The electrophotographic photoreceptor according to the present exemplary embodiment (hereinafter, also referred to as “photoreceptor”) includes a conductive substrate, an undercoat layer disposed on the conductive substrate, and a photosensitive layer disposed on the undercoat layer.

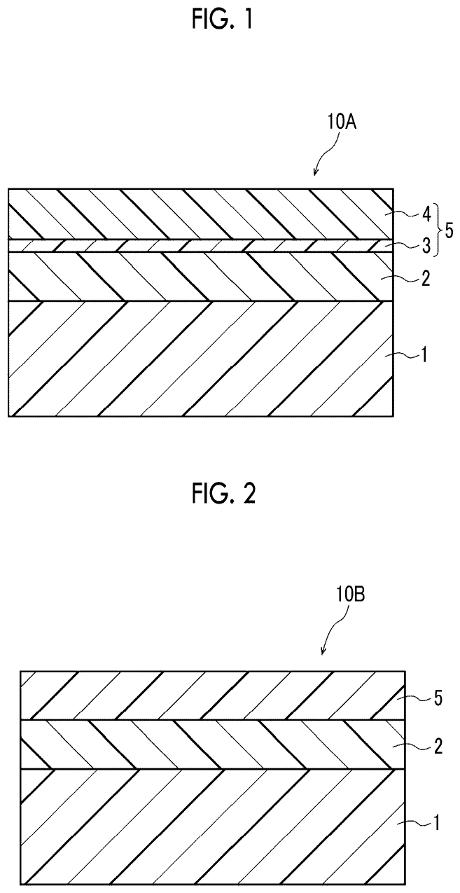

FIG. 1 is a partial cross-sectional view showing an example of a layer configuration of a photoreceptor according to the present exemplary embodiment. A photoreceptor 10A shown in FIG. 1 includes a lamination type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation type photosensitive layer). The photoreceptor 10A may include an interlayer (not shown) between the undercoat layer 2 and the charge generation layer 3. The photoreceptor 10A may include a protective layer (not shown) on the charge transport layer 4.

FIG. 2 is a partial cross-sectional view schematically showing another example of the layer configuration of the photoreceptor according to the present exemplary embodiment. A photoreceptor 10B shown in FIG. 2 includes a single layer type photosensitive layer. The photoreceptor 10B has a structure in which the undercoat layer 2 and the photosensitive layer 5 are laminated in this order on the conductive substrate 1. The photoreceptor 10B may include an interlayer (not shown) between the undercoat layer 2 and the photosensitive layer 5. The photoreceptor 10B may include a protective layer (not shown) on the photosensitive layer 5.

In the photoreceptor according to the present exemplary embodiment, the undercoat layer contains an organic pigment and a binder resin and satisfies Expressions (A1) and (B1).

εr(Max)≤7.0 Expression (A1)

tan δ(Max)≤0.5 Expression (B1)
εr (Max) represents a maximum value of a relative permittivity at a measurement frequency of 10 Hz to 3,000 Hz, which is acquired by measuring an impedance of the undercoat layer at a temperature of 22° C. and a relative humidity of 50%.
tan δ(Max) represents a maximum value of a dielectric loss tangent at a measurement frequency of 10 Hz to 3,000 Hz, which is acquired by measuring an impedance of the undercoat layer at a temperature of 22° C. and a relative humidity of 50%.

In the photoreceptor according to the present exemplary embodiment, since the undercoat layer is in the form described above, spot-like image defects are unlikely to occur. The mechanism is assumed as follows.

Foreign matter formed by aggregation of paper dust, a toner, fibers, a resin of a deteriorated member, and the like is generated inside the image forming apparatus, and the foreign matter may be stuck into the outer peripheral surface of the photoreceptor. In a case where the foreign matter is stuck into the outer peripheral surface of the photoreceptor, the layer thickness of the portion of the photoreceptor (the distance between the foreign matter and the conductive substrate) is thinner than the original layer thickness of the photoreceptor. Therefore, the electric field in a portion with a small layer thickness increases in a case where the photoreceptor is charged, pinhole leakage of a current is likely to occur, and the charging potential of the portion is likely to decrease. As a result, spot-like image defects may occur.

Here, in a case where the charging device is a charging device of a type that the photoreceptor is charged by superimposing an alternating current voltage on a direct current voltage and applying the voltage (referred to as “AC/DC charging type”), the leakage of the current in the portion with a small layer thickness and a decrease in charging potential are significant. The reason for this is considered to be that an alternating current electric field is formed in the photoreceptor in a case of the AC/DC charging type, and dielectric loss in which a part of the electric energy is converted to heat and lost occurs. It is considered that the dielectric loss (that is, heat generation) in the portion with a small layer thickness causes dielectric breakdown of the portion, and thus the leakage of the current in the portion and a decrease in charging potential are significant.

In response to the above-described phenomenon, in the present exemplary embodiment, an undercoat layer in which the dielectric loss is unlikely to occur is obtained by decreasing the values of the relative permittivity (εr) and the dielectric loss tangent (tan δ) of the undercoat layer, and as a result, occurrence of spot-like image defects is suppressed even in a case where the thickness of the photosensitive layer decreases due to the sticking of the foreign matter.

In the photoreceptor according to the present exemplary embodiment, the εr (Max) of the undercoat layer is 7.0 or less. In other words, the value of the relative permittivity (εr) at a measurement frequency of 10 Hz to 3,000 Hz does not exceed 7.0.

In a case where the εr (Max) of the undercoat layer is greater than 7.0, dielectric loss (that is, heat generation) leading to dielectric breakdown is likely to occur. From the viewpoint of suppressing occurrence of dielectric breakdown, the εr (Max) of the undercoat layer is 7.0 or less, for example, preferably 5.5 or less, and more preferably 5.0 or less. It is desirable that the εr (Max) of the undercoat layer, for example, decreases.

In the photoreceptor according to the present exemplary embodiment, the tan δ(Max) of the undercoat layer is 0.5 or less. In other words, the value of the dielectric loss tangent (tan δ) at a measurement frequency of 10 Hz to 3,000 Hz does not exceed 0.5.

In a case where the tan δ(Max) of the undercoat layer is greater than 0.5, dielectric loss (that is, heat generation) leading to dielectric breakdown is likely to occur. From the viewpoint of suppressing occurrence of dielectric breakdown, the tan δ(Max) of the undercoat layer is 0.5 or less, for example, preferably 0.4 or less, and more preferably 0.3 or less. It is desirable that the tan δ(Max) of the undercoat layer, for example, decreases.

It is preferable that the undercoat layer satisfies, for example, Expressions (A2) and (B2).

εr(Max)≤5.5 Expression (A2)

tan δ(Max)≤0.4 Expression (B2)

It is more preferable that the undercoat layer satisfies, for example, Expressions (A3) and (B3).

εr(Max)≤5.0 Expression (A3)

tan δ(Max)≤0.3 Expression (B3)

The impedance of the undercoat layer is measured as follows.

An undercoat layer disposed on the conductive substrate is prepared. The undercoat layer is an undercoat layer exposed before another layer is provided on the outer peripheral surface or an undercoat layer exposed by peeling off another layer on the outer peripheral surface.

A gold electrode having a diameter of 6 mm is formed on the outer peripheral surface of the undercoat layer by a vacuum deposition method and used as a measurement sample. The measurement sample is placed in an environment of a temperature of 22° C. and a relative humidity of 50% for 12 hours or longer.

An impedance measuring device (for example, an impedance analyzer 126096W type, manufactured by Solartron) is connected to the gold electrode and the conductive substrate, and the impedance is measured under the following measurement conditions to acquire the relative permittivity (εr) and the dielectric loss tangent (tan δ).
Measurement environment: temperature of 22° C. and relative humidity of 50%
Direct current applied voltage: 0 V
Alternating current applied voltage: ±1 V
Frequency: sweep from 1 Hz to 10 kHz

The values of the relative permittivity (εr) and the dielectric loss tangent (tan δ) of the undercoat layer tend to be lower as the dispersibility of the particulate substance contained in the undercoat layer is more satisfactory. For example, the values of εr and tan δ of the undercoat layer can be decreased by a method of reducing the particle diameter of the particulate substance provided for production of a coating solution for forming an undercoat layer, a method of lengthening the time for performing a dispersion treatment on a coating solution for forming an undercoat layer, or a method of removing aggregates from a coating solution for forming an undercoat layer.

Hereinafter, each layer of the photoreceptor according to the present exemplary embodiment will be described in detail.

Undercoat Layer

The undercoat layer contains an organic pigment and a binder resin. The undercoat layer may contain inorganic particles and other additives.

Organic Pigment

For example, an organic pigment that functions as an electron-accepting compound (acceptor compound) in the undercoat layer is preferable as the organic pigment.

Examples of the organic pigment serving as an electron-accepting compound include a perinone compound, a naphthalenediimide compound, an anthraquinone compound, a hydroxyanthraquinone compound, an aminoanthraquinone compound, an aminohydroxyanthraquinone compound, a quinone compound, a tetracyanoquinodimethane compound, a fluorenone compound, an oxadiazole compound, a xanthone compound, a thiophene compound, a diphenoquinone compound, and a benzophenone compound. The organic pigment may be used alone or in combination of two or more kinds thereof.

From the viewpoint of imparting electrical characteristics appropriate for electrophotography to the undercoat layer, the proportion of the total amount of the organic pigment in the total amount of the undercoat layer is, for example, preferably 50% by mass or greater and 75% by mass or less, more preferably 50% by mass or greater and 70% by mass or less, still more preferably 55% by mass or greater and 70% by mass or less, and even still more preferably 60% by mass or greater and 70% by mass or less.

From the viewpoint of imparting electrical characteristics appropriate for electrophotography to the undercoat layer, for example, at least one selected from the group consisting of a perinone compound and a naphthalenediimide compound is preferable, and at least one selected from the perinone compound is more preferable as the organic pigment.

As the naphthalenediimide compound, for example, a naphthalenetetracarboxylic acid diimide derivative is preferable, and a 1,4,5,8-naphthalenetetracarboxylic acid diimide derivative is more preferable.

Among the perinone compounds, for example, at least one selected from the group consisting of a compound represented by Formula (1) and a compound represented by Formula (2) is preferable as the organic pigment from the viewpoint of imparting electrical characteristics appropriate for electrophotography to the undercoat layer.

In the present disclosure, the compound represented by Formula (1) is referred to as a perinone compound (1), and the compound represented by Formula (2) is referred to as a perinone compound (2). Hereinafter, the perinone compound (1) and the perinone compound (2) will be described in detail.

Perinone Compound (1) and Perinone Compound (2)

The perinone compound (1) is a compound represented by Formula (1). The perinone compound (2) is a compound represented by Formula (2).

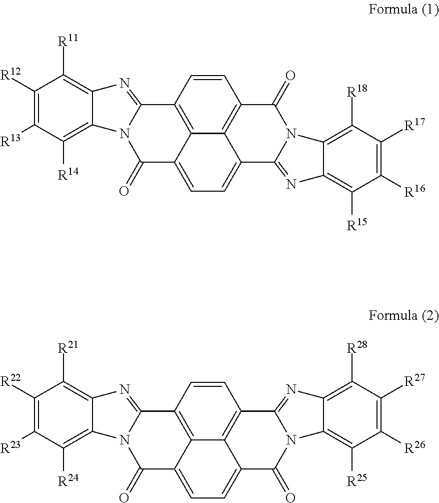

In Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, and an alkoxycarbonyl group, an aryloxycarbonyl group, an alkoxycarbonylalkyl group, an aryloxycarbonylalkyl group, or a halogen atom. R¹¹ and R¹², R¹² and R¹³, and R¹³ and R¹⁴ may be each independently linked to each other to form a ring. R¹⁵ and R¹⁶, R¹⁶ and R¹⁷, and R¹⁷ and R¹⁸ may be each independently linked to each other to form a ring.

In Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom. R²¹ and R²², R²² and R²³, and R²³ and R²⁴ may be each independently linked to each other to form a ring. R²⁵ and R²⁶, R²⁶ and R²⁷, and R²⁷ and R²⁸ may be each independently linked to each other to form a ring.

Examples of the alkyl group represented by R¹¹ to R¹⁸ in Formula (1) include substituted or unsubstituted alkyl groups.

Examples of the unsubstituted alkyl group represented by R¹¹ to R¹⁸ in Formula (1) include a linear alkyl group having 1 or more and 20 or less carbon atoms (for example, preferably 1 or more and 10 or less carbon atoms and more preferably 1 or more and 6 or less carbon atoms), a branched alkyl group having 3 or more and 20 or less carbon atoms (for example, preferably 3 or more and 10 or less carbon atoms), and a cyclic alkyl group having 3 or more and 20 or less carbon atoms (for example, preferably 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups formed by these monocyclic alkyl groups being linked to each other.

Among these, for example, a linear alkyl group such as a methyl group or an ethyl group is preferable as the unsubstituted alkyl group.

Examples of the substituent in the alkyl group include an alkoxy group, a hydroxy group, a carboxy group, a nitro group, and a halogen atom (such as a fluorine atom, a bromine atom, or an iodine atom).

Examples of the alkoxy group that substitutes the hydrogen atom in the alkyl group include the same groups as the groups for the unsubstituted alkoxy group represented by R¹¹ to R¹⁸ in Formula (1).

Examples of the alkoxy group represented by R¹¹ to R¹⁸ in Formula (1) include a substituted or unsubstituted alkoxy group.

Examples of the unsubstituted alkoxy group represented by R¹¹ to R¹⁸ in Formula (1) include a linear, branched, or cyclic alkoxy group having 1 or more and 10 or less carbon atoms (for example, preferably 1 or more and 6 or less carbon atoms and more preferably 1 or more and 4 or less carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, and an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group.

Among these, for example, a linear alkoxy group is preferable as the unsubstituted alkoxy group.

Examples of the substituent in the alkoxy group include an aryl group, an alkoxycarbonyl group, an aryloxycarbonyl group, a hydroxyl group, a carboxy group, a nitro group, and a halogen atom (such as a fluorine atom, a bromine atom, or an iodine atom).

Examples of the aryl group that substitutes a hydrogen atom in the alkoxy group include the same groups as the groups for the unsubstituted aryl group represented by R¹¹ to R¹⁸ in Formula (1).

Examples of the alkoxycarbonyl group that substitutes a hydrogen atom in the alkoxy group include the same groups as the groups for the unsubstituted alkoxycarbonyl group represented by R¹¹ to R¹⁸ in Formula (1).

Examples of the aryloxycarbonyl group that substitutes a hydrogen atom in the alkoxy group include the same groups as the groups for the unsubstituted aryloxycarbonyl group represented by R¹¹ to R¹⁸ in Formula (1).

Examples of the aralkyl group represented by R¹¹ to R¹⁸ in Formula (1) include a substituted or unsubstituted aralkyl group.

In Formula (1), as the unsubstituted aralkyl group represented by R¹¹ to R¹⁸, for example, an aralkyl group having 7 or more and 30 or less carbon atoms is preferable, an aralkyl group having 7 or more and 16 or less carbon atoms is more preferable, and an aralkyl group having 7 or more and 12 or less carbon atoms is still more preferable.

Examples of the unsubstituted aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

Examples of the substituent in the aralkyl group include an alkoxy group, an alkoxycarbonyl group, an aryloxycarbonyl group, and a halogen atom (such as a fluorine atom, a bromine atom, or an iodine atom).

Examples of the alkoxy group that substitutes a hydrogen atom in the aralkyl group include the same groups as the groups for the unsubstituted alkoxy group represented by R¹¹ to R¹⁸ in Formula (1).

Examples of the alkoxycarbonyl group that substitutes a hydrogen atom in the aralkyl group include the same groups as the groups for the unsubstituted alkoxycarbonyl group represented by R¹¹ to R¹⁸ in Formula (1).

Examples of the aryloxycarbonyl group that substitutes a hydrogen atom in the aralkyl group include the same groups as the groups for the unsubstituted aryloxycarbonyl group represented by R¹¹ to R¹⁸ in Formula (1).

Examples of the aryl group represented by R¹¹ to R¹⁸ in Formula (1) include a substituted or unsubstituted aryl group.

As the unsubstituted aryl group represented by R¹¹ to R¹⁸ in Formula (1), for example, an aryl group having 6 or more and 30 or less carbon atoms is preferable, an aryl group having 6 or more and 14 or less carbon atoms is more preferable, and an aryl group having 6 or more and 10 or less carbon atoms is still more preferable.

Examples of the aryl group having 6 or more and 30 or less carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quarter anthracenyl group, an anthraquinolyl group, a phenanthryl group, a triphenylenyl group, a pyrenyl group, a chrysenyl group, a naphthacenyl group, a preadenyl group, a picenyl group, a perylenyl group, a pentaphenyl group, a pentacenyl group, tetraphenylenyl group, a hexaphenyl group, a hexacenyl group, a rubisenyl group, and a coronenyl group. Among these, for example, a phenyl group is preferable.

Examples of the substituent in the aryl group include an alkyl group, an alkoxy group, an alkoxycarbonyl group, an aryloxycarbonyl group, and a halogen atom (such as a fluorine atom, a bromine atom, or an iodine atom).

Examples of the alkyl group that substitutes a hydrogen atom in the aryl group include the same groups as the groups for the unsubstituted alkyl group represented by R¹¹ to R¹⁸ in Formula (1).

Examples of the alkoxy group that substitutes a hydrogen atom in the aryl group include the same groups as the groups for the unsubstituted alkoxy group represented by R¹¹ to R¹⁸ in Formula (1).

Examples of the alkoxycarbonyl group that substitutes a hydrogen atom in the aryl group include the same groups as the groups for the unsubstituted alkoxycarbonyl group represented by R¹¹ to R¹⁸ in Formula (1).

Examples of the aryloxycarbonyl group that substitutes a hydrogen atom in the aryl group include the same groups as the groups for the unsubstituted aryloxycarbonyl group represented by R¹¹ to R¹⁸ in Formula (1).

Examples of the aryloxy group represented by R¹¹ to R¹⁸ in Formula (1) (—O—Ar, Ar represent an aryl group) include a substituted or unsubstituted aryloxy group.

As the unsubstituted aryloxy group represented by R¹¹ to R¹⁸ in Formula (1), for example, an aryloxy group having 6 or more and 30 or less carbon atoms is preferable, an aryloxy group having 6 or more and 14 or less carbon atoms is more preferable, and an aryloxy group having 6 or more and 10 or less carbon atoms is still more preferable.

Examples of the aryloxy group having 6 or more and 30 or less carbon atoms include a phenyloxy group (phenoxy group), a biphenyloxy group, a 1-naphthyloxy group, a 2-naphthyloxy group, a 9-anthryloxy group, a 9-phenanthryloxy group, a 1-pyrenyloxy group, a 5-naphthacenyloxy group, a 1-indenyloxy group, a 2-azulenyloxy group, a 9-fluorenyloxy group, a biphenylenyloxy group, an indacenyloxy group, a fluoranthenyloxy group, an acenaphthylenyloxy group, an aceanthryleneyloxy group, a phenalenyloxy group, a fluorenyloxy group, an anthryloxy group, a bianthracenyloxy group, a teranthracenyloxy group, a quarter anthracenyloxy group, an anthraquinolyloxy group, a phenanthryloxy group, a triphenylenyloxy group, a pyrenyloxy group, a chrysenyloxy group, a naphthacenyloxy group, a preadenyloxy group, a picenyloxy group, a perylenyloxy group, a pentaphenyloxy group, a pentacenyloxy group, a tetraphenylenyloxy group, a hexaphenyloxy group, a hexacenyloxy group, a rubisenyloxy group, and a coronenyloxy group. Among these, for example, a phenyloxy group (phenoxy group) is preferable.

Examples of the substituent in the aryloxy group include an alkyl group, an alkoxycarbonyl group, an aryloxycarbonyl group, and a halogen atom (such as a fluorine atom, a bromine atom, or an iodine atom).

Examples of the alkyl group that substitutes a hydrogen atom in the aryloxy group include the same groups as the groups for the unsubstituted alkyl group represented by R¹¹ to R¹⁸ in Formula (1).

Examples of the alkoxycarbonyl group that substitutes a hydrogen atom in the aryloxy group include the same groups as the groups for the unsubstituted alkoxycarbonyl group represented by R¹¹ to R¹⁸ in Formula (1).

Examples of the aryloxycarbonyl group that substitutes a hydrogen atom in the aryloxy group include the same groups as the groups for the unsubstituted aryloxycarbonyl group represented by R¹¹ to R¹⁸ in Formula (1).

Examples of the alkoxycarbonyl group represented by R¹¹ to R¹⁸ (—CO—OR, R represent an alkyl group) in Formula (1) include a substituted or unsubstituted alkoxycarbonyl group.

The number of carbon atoms of the alkyl chain in the unsubstituted alkoxycarbonyl group represented by R¹¹ to R¹⁸ in Formula (1) is, for example, preferably 1 or more and 20 or less, more preferably 1 or more and 15 or less, and still more preferably 1 or more and 10 or less.

Examples of the alkoxycarbonyl group having 1 or more and 20 or less carbon atoms in the alkyl chain include a methoxycarbonyl group, an ethoxycarbonyl group, a propoxycarbonyl group, an isopropoxycarbonyl group, an n-butoxycarbonyl group, a sec-butoxybutylcarbonyl group, and a tert-butoxycarbonyl group, a pentaoxycarbonyl group, a hexaoxycarbonyl group, a heptaoxycarbonyl group, an octaoxycarbonyl group, a nonaoxycarbonyl group, a decaoxycarbonyl group, a dodecaoxycarbonyl group, a tridecaoxycarbonyl group, a tetradecaoxycarbonyl group, a pentadecaoxycarbonyl group, a hexadecaoxycarbonyl group, a heptadecaoxycarbonyl group, an octadecaoxycarbonyl group, a nonadecaoxycarbonyl group, and an icosaoxycarbonyl group.

Examples of the substituent in the alkoxycarbonyl group include an aryl group, a hydroxy group, and a halogen atom (such as a fluorine atom, a bromine atom, or an iodine atom).

Examples of the aryl group that substitutes a hydrogen atom in the alkoxycarbonyl group include the same groups as the groups for the unsubstituted aryl group represented by R¹¹ to R¹⁸ in Formula (1).

Examples of the aryloxycarbonyl group represented by R¹¹ to R¹⁸ (—CO—OAr, Ar represents an aryl group) in Formula (1) include a substituted or unsubstituted aryloxycarbonyl group.

The number of carbon atoms of the aryl group in the unsubstituted aryloxycarbonyl group represented by R¹¹ to R¹⁸ in Formula (1) is, for example, preferably 6 or more and 30 or less, more preferably 6 or more and 14 or less, and still more preferably 6 or more and 10 or less.

Examples of the aryloxycarbonyl group containing an aryl group with 6 or more and 30 or less carbon atoms include a phenoxycarbonyl group, a biphenyloxycarbonyl group, a 1-naphthyloxycarbonyl group, a 2-naphthyloxycarbonyl group, a 9-anthryloxycarbonyl group, a 9-phenanthryloxycarbonyl group, a 1-pyrenyloxycarbonyl group, a 5-naphthacenyloxycarbonyl group, a 1-indenyloxycarbonyl group, a 2-azulenyloxycarbonyl group, a 9-fluorenyloxycarbonyl group, a biphenylenyloxycarbonyl group, an indacenyloxycarbonyl group, a fluoranthenyloxycarbonyl group, an acenaphthylenyloxycarbonyl group, an aceanthryleneyloxycarbonyl group, a phenalenyloxycarbonyl group, a fluorenyloxycarbonyl group, an anthryloxycarbonyl group, a bianthracenyloxycarbonyl group, a teranthracenyloxycarbonyl group, a quarter anthracenyloxycarbonyl group, an anthraquinolyloxycarbonyl group, a phenanthryloxycarbonyl group, a triphenylenyloxycarbonyl group, a pyrenyloxycarbonyl group, a chrysenyloxycarbonyl group, a naphthacenyloxycarbonyl group, a preadenyloxycarbonyl group, a picenyloxycarbonyl group, a perylenyloxycarbonyl group, a pentaphenyloxycarbonyl group, a pentacenyloxycarbonyl group, a tetraphenylenyloxycarbonyl group, a hexaphenyloxycarbonyl group, a hexacenyloxycarbonyl group, a rubisenyloxycarbonyl group, and a coronenyloxycarbonyl group. Among these, for example, a phenoxycarbonyl group is preferable.

Examples of the substituent in the aryloxycarbonyl group include an alkyl group, a hydroxy group, and a halogen atom (such as a fluorine atom, a bromine atom, or an iodine atom).

Examples of the alkyl group that substitutes a hydrogen atom of the aryloxycarbonyl group include the same groups as the groups for the unsubstituted alkyl group represented by R¹¹ to R¹⁸ in Formula (1).

Examples of the alkoxycarbonylalkyl group represented by R¹¹ to R¹⁸ (—(CₙH₂ₙ)—CO—OR, R represents an alkyl group, and n represents an integer of 1 or greater) in Formula (1) include a substituted or unsubstituted alkoxycarbonylalkyl group.

Examples of the alkoxycarbonyl group (—CO—OR) in the unsubstituted alkoxycarbonylalkyl group represented by R¹¹ to R¹⁸ in Formula (1) include the same groups as the groups for the alkoxycarbonyl group represented by R¹¹ to R¹⁸ in Formula (1).

Examples of the alkylene chain (—CₙH₂ₙ—) in the unsubstituted alkoxycarbonylalkyl group represented by R¹¹ to R¹⁸ in Formula (1) include a linear alkylene chain having 1 or more and 20 or less carbon atoms (for example, preferably 1 or more and 10 or less carbon atoms and more preferably 1 or more and 6 or less carbon atoms), a branched alkylene chain having 3 or more and 20 or less carbon atoms (for example, preferably 3 or more and 10 or less carbon atoms), and a cyclic alkylene chain having 3 or more and 20 or less carbon atoms (for example, preferably 3 or more and 10 or less carbon atoms).

Examples of the linear alkylene chain having 1 or more and 20 or less carbon atoms include a methylene group, an ethylene group, an n-propylene group, an n-butylene group, an n-pentylene group, an n-hexylene group, an n-heptylene group, an n-octylene group, an n-nonylene group, an n-decylene group, an n-undecylene group, an n-dodecylene group, a tridecylene group, an n-tetradecylene group, an n-pentadecylene group, an n-heptadecylene group, an n-octadecylene group, an n-nonadecylene group, and an n-icosylene group.

Examples of the branched alkylene chain having 3 or more and 20 or less carbon atoms include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a tert-decylene group, an isododecylene group, a sec-dodecylene group, a tert-dodecylene group, a tert-tetradecylene group, and a tert-pentadecylene group.

Examples of the cyclic alkylene chain having 3 or more and 20 or less carbon atoms include a cyclopropylene group, a cyclobutylene group, a cyclopentylene group, a cyclohexylene group, a cycloheptyrene group, a cyclooctylene group, a cyclononylene group, and a cyclodecylene group.

Examples of the substituent in the alkoxycarbonylalkyl group include an aryl group, a hydroxy group, and a halogen atom (such as a fluorine atom, a bromine atom, or an iodine atom).

Examples of the aryl group that substitutes a hydrogen atom of the alkoxycarbonylalkyl group include the same groups as the groups for the unsubstituted aryl group represented by R¹¹ to R¹⁸ in Formula (1).

Examples of the aryloxycarbonylalkyl groups represented by R¹¹ to R¹⁸ (—(CₙH₂ₙ)—CO—OAr, Ar represents an aryl group, and n represents an integer of 1 or greater) in Formula (1) include a substituted or unsubstituted aryloxycarbonylalkyl group.

Examples of the aryloxycarbonyl group (—CO—OAr, Ar represents an aryl group) in the unsubstituted aryloxycarbonylalkyl group represented by R¹¹ to R¹⁸ in Formula (1) include the same groups as the groups for the aryloxycarbonyl group represented by R¹¹ to R¹⁸ in Formula (1).

Examples of the alkylene chain (—CₙH₂ₙ—) in the unsubstituted aryloxycarbonylalkyl group represented by R¹¹ to R¹⁸ in Formula (1) include the same groups as the groups for the alkylene chain in the alkoxycarbonylalkyl group represented by R¹¹ to R¹⁸ in Formula (1).

Examples of the substituent in the aryloxycarbonylalkyl group include an alkyl group, a hydroxy group, and a halogen atom (such as a fluorine atom, a bromine atom, or an iodine atom).

Examples of the alkyl group that substitutes a hydrogen atom of the aryloxycarbonylalkyl group include the same groups as the groups for the unsubstituted alkyl group represented by R¹¹ to R¹⁸ in Formula (1).

Examples of the halogen atom represented by R¹¹ to R¹⁸ in Formula (1) include a fluorine atom, a chlorine atom, a bromine atom, and an iodine atom.

Examples of the ring structure formed by R¹¹ and R¹², R¹² and R¹³, R¹³ and R¹⁴, R¹⁵ and R¹⁶, R¹⁶ and R¹⁷, or R¹⁷ and R¹⁸ in Formula (1) being linked to each other include a benzene ring and a fused ring having 10 or more and 18 or less carbon atoms (such as a naphthalene ring, an anthracene ring, a phenanthrene ring, a chrysene ring (benzo[α]phenanthrene ring), a tetracene ring, a tetraphene ring (benzo[α]anthracene ring), or a triphenylene ring). Among these, for example, a benzene ring is preferable as the ring structure to be formed.

Examples of the alkyl group represented by R²¹ to R²⁸ in Formula (2) include the same groups as the groups for the alkyl group represented by R¹¹ to R¹⁸ in Formula (1).

Examples of the alkoxy groups represented by R²¹ to R²⁸ in Formula (2) include the same groups as the groups for the alkoxy group represented by R¹¹ to R¹⁸ in Formula (1).

Examples of the aralkyl group represented by R²¹ to R²⁸ in Formula (2) include the same groups as the groups for the aralkyl group represented by R¹¹ to R¹⁸ in Formula (1).

Examples of the aryl group represented by R²¹ to R²⁸ in Formula (2) include the same groups as the groups for the aryl group represented by R¹¹ to R¹⁸ in Formula (1).

Examples of the aryloxy group represented by R²¹ to R²⁸ in Formula (2) include the same groups as the groups for the aryloxy group represented by R¹¹ to R¹⁸ in Formula (1).

Examples of the alkoxycarbonyl group represented by R²¹ to R²⁸ in Formula (2) include the same groups as the groups for the alkoxycarbonyl group represented by R¹¹ to R¹⁸ in Formula (1).

Examples of the aryloxycarbonyl group represented by R²¹ to R²⁸ in Formula (2) include the same groups as the groups for the aryloxycarbonyl group represented by R¹¹ to R¹⁸ in Formula (1).

Examples of the alkoxycarbonylalkyl group represented by R²¹ to R²⁸ in Formula (2) include the same groups as the groups for the alkoxycarbonylalkyl group represented by R¹¹ to R¹⁸ in Formula (1).

Examples of the aryloxycarbonylalkyl group represented by R²¹ to R²⁸ in Formula (2) include the same groups as the groups for the aryloxycarbonylalkyl group represented by R¹¹ to R¹⁸ in Formula (1).

Examples of the halogen atom represented by R²¹ to R²⁸ in Formula (2) include the same atoms as the atoms for the halogen atom represented by R¹¹ to R¹⁸ in Formula (1).

Examples of the ring structure formed by R²¹ and R²², R²² and R²³, R²³ and R²⁴, R²⁵ and R²⁶, R²⁶ and R²⁷, or R²⁷ and R²⁸ in Formula (2) being linked to each other include a benzene ring and a fused ring having 10 or more and 18 or less carbon atoms (such as a naphthalene ring, an anthracene ring, a phenanthrene ring, a chrysene ring (benzo[α]phenanthrene ring), a tetracene ring, a tetraphene ring (benzo[α]anthracene ring), or a triphenylene ring). Among these, for example, a benzene ring is preferable as the ring structure to be formed.

It is preferable that R¹², R¹³, R¹⁴, R¹⁵, R¹⁶, R¹⁷, and R¹⁸ in Formula (1) each independently represent, for example, a hydrogen atom, an alkyl group, an alkoxycarbonyl group, an aryloxycarbonyl group, an alkoxycarbonylalkyl group, or an aryloxycarbonylalkyl group.

It is preferable that R²¹, R²², R²³, R²⁴, R²⁵, R²⁶, R²⁷, and R²⁸ in Formula (2) each independently represent, for example, a hydrogen atom, an alkyl group, an alkoxycarbonyl group, an aryloxycarbonyl group, an alkoxycarbonylalkyl group, or an aryloxycarbonylalkyl group.

Hereinafter, specific examples of the perinone compound (1) and the perinone compound (2) will be shown, but the present exemplary embodiment is not limited thereto. In the following structural formulae, Ph represents a phenyl group.

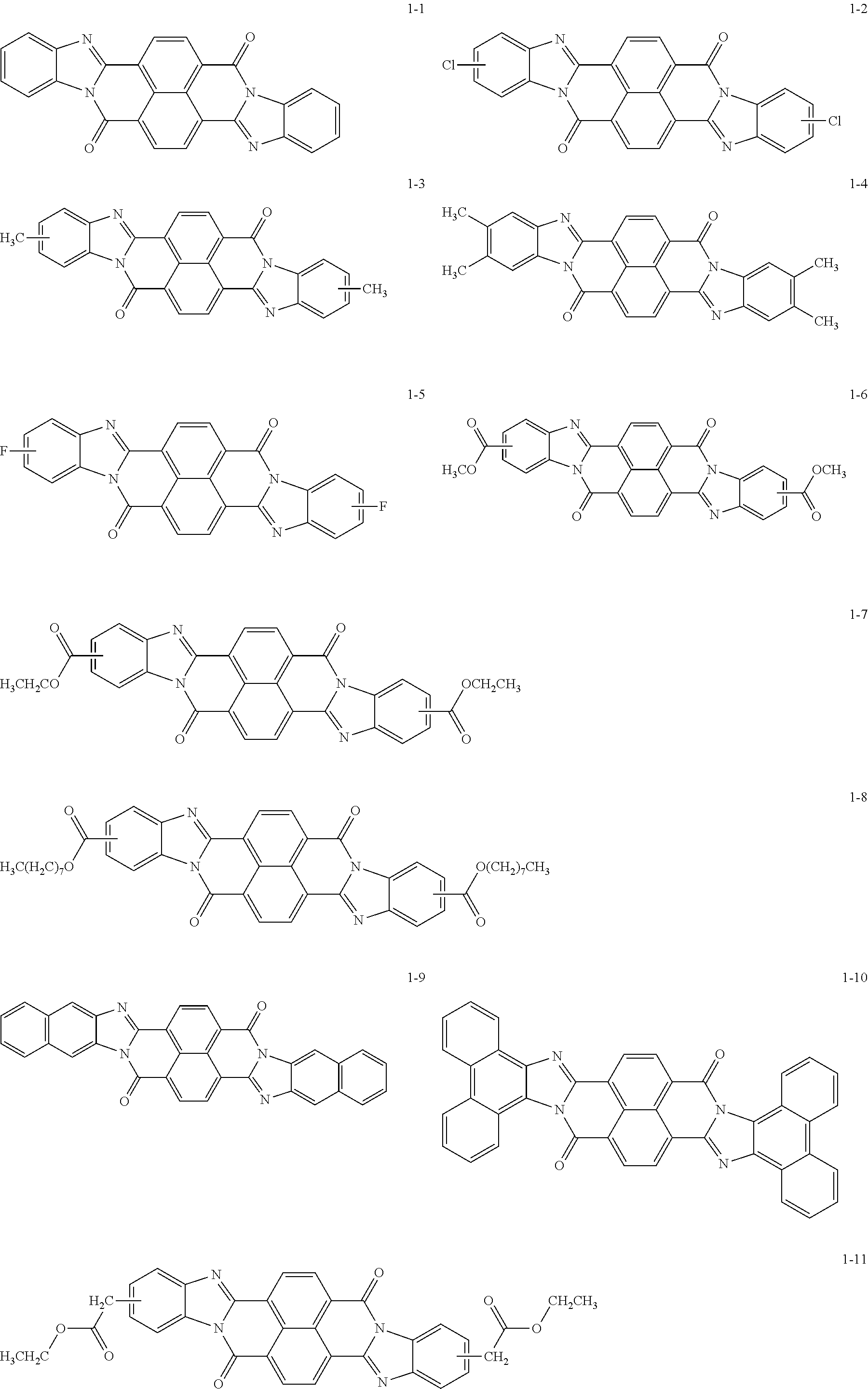

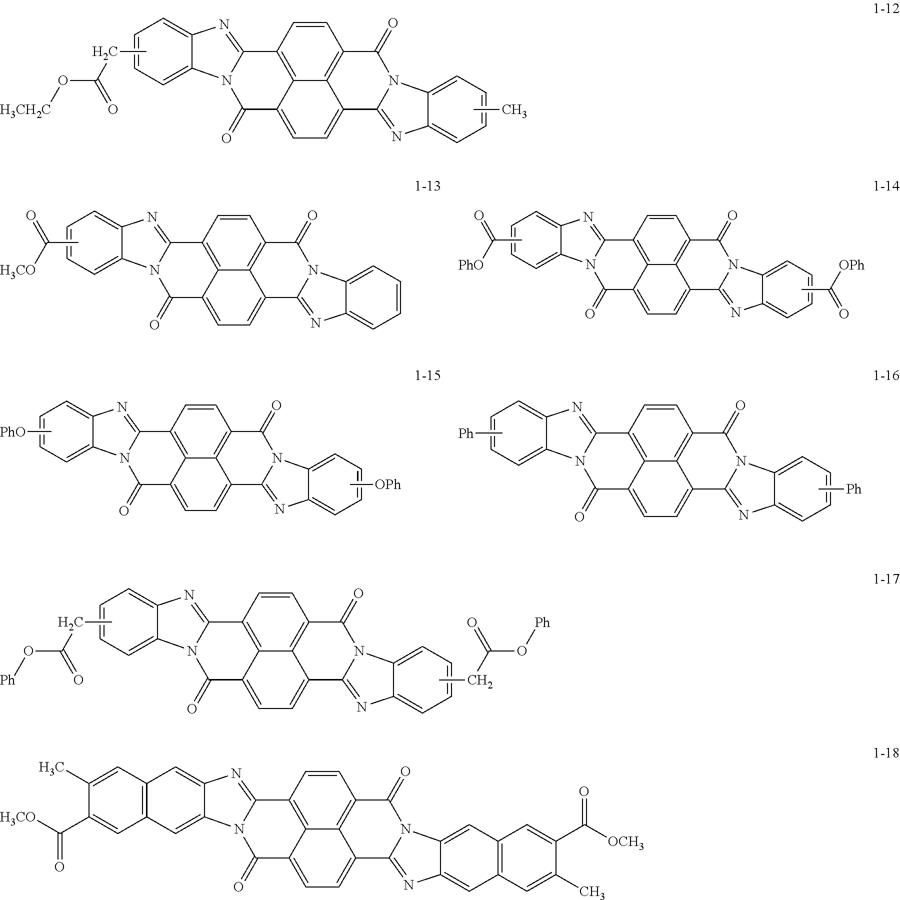

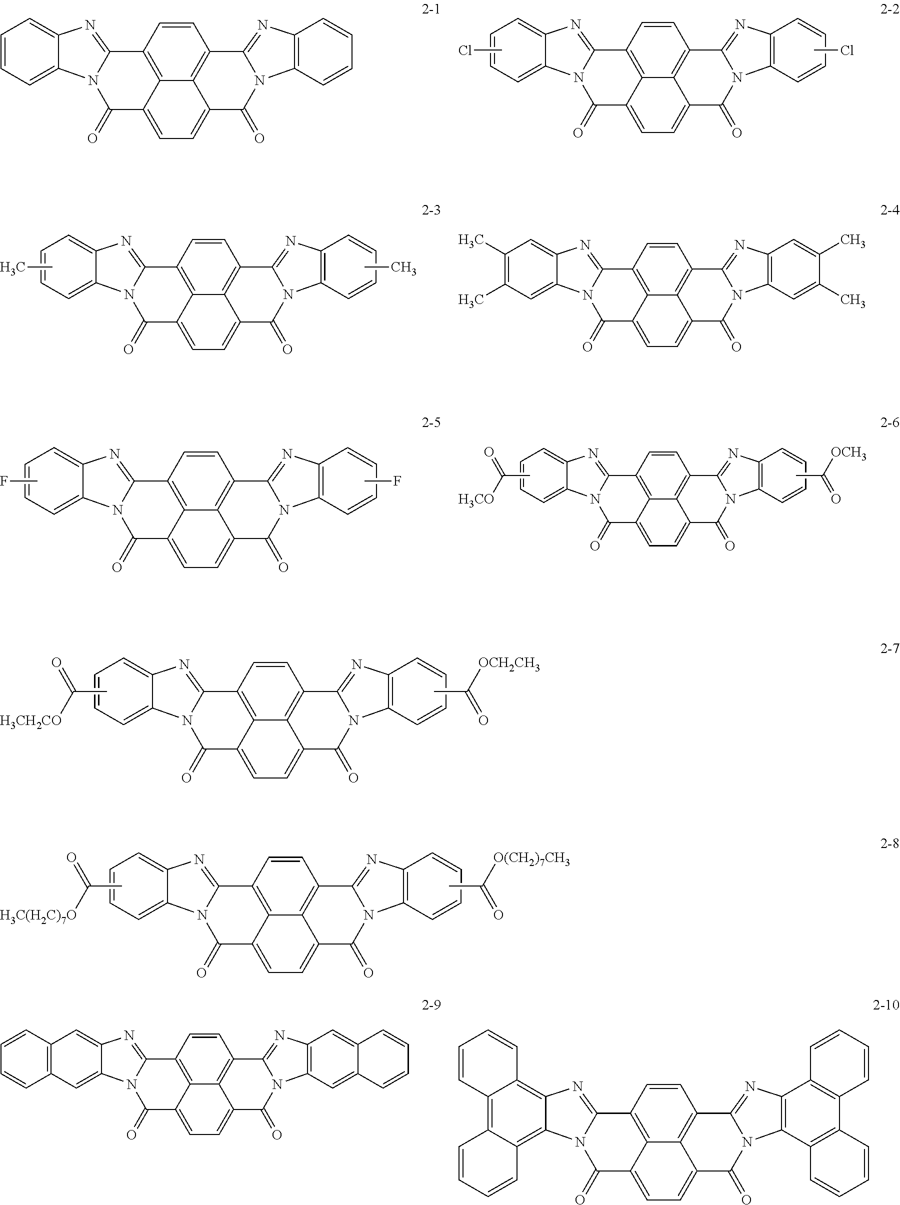

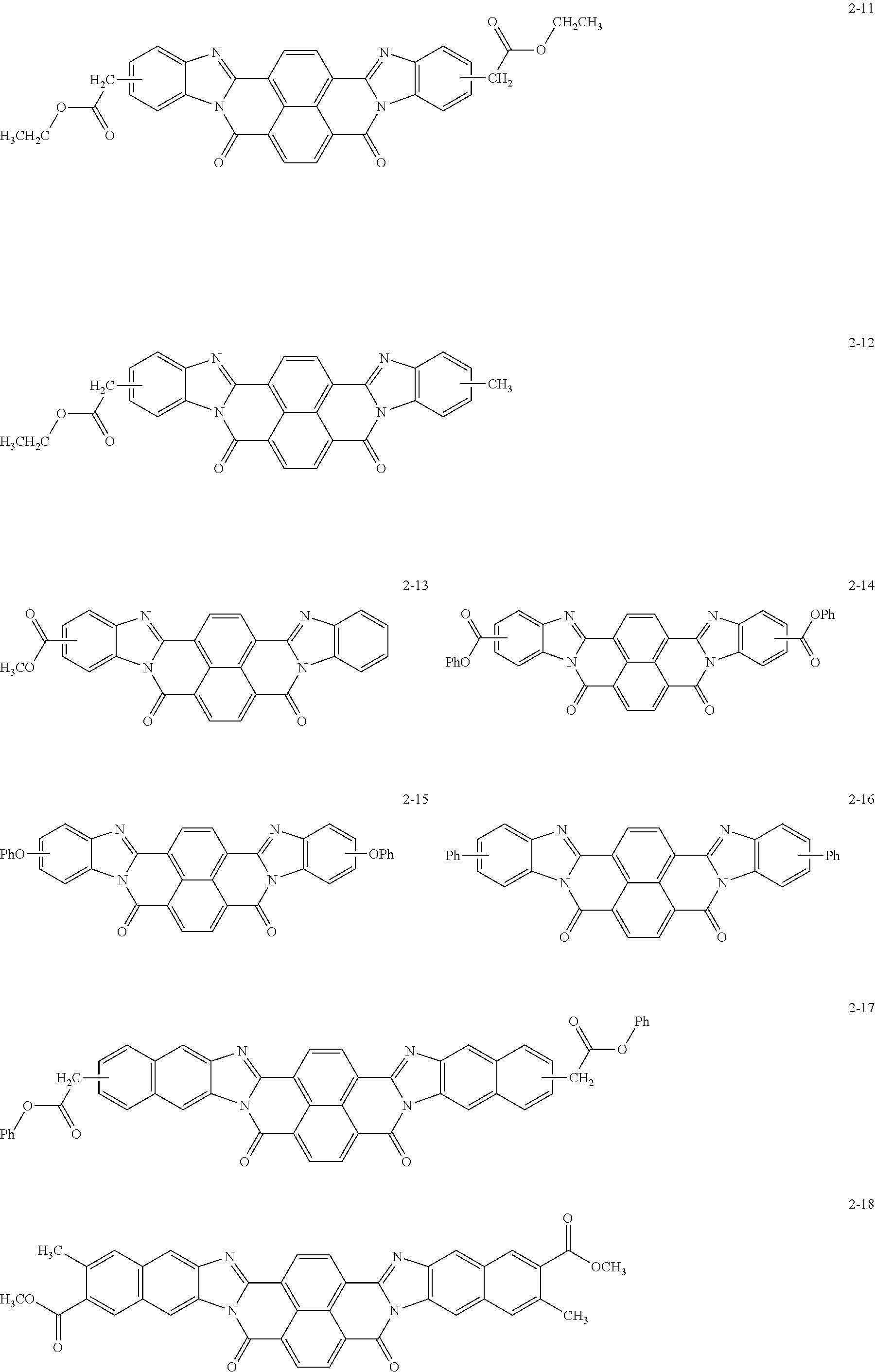

The perinone compound (1-1) and the perinone compound (2-1) have an isomer relationship (relationship between a cis form and a trans form). Therefore, a mixture of the perinone compounds is likely to be obtained by a synthetic method, and the mixing ratio therebetween is typically 1:1. One of the mixture of the perinone compound (1-1) and the perinone compound (2-1) can be purified from the mixture by a known purification method. The same applies to other perinone compounds having a relationship between a cis form and a trans form.

From the viewpoint of imparting electrical characteristics appropriate for electrophotography to the undercoat layer, the proportion of the total amount of the perinone compound (1) and the perinone compound (2) in the total amount of the undercoat layer is, for example, preferably 50% by mass or greater and 75% by mass or less, more preferably 50% by mass or greater and 70% by mass or less, still more preferably 55% by mass or greater and 70% by mass or less, and even still more preferably 60% by mass or greater and 70% by mass or less.

The total amount of the perinone compound (1) and the perinone compound (2) contained in the undercoat layer is, for example, preferably 80% by mass or greater, more preferably 90% by mass or greater, still more preferably 95% by mass or greater, and particularly preferably 100% by mass with respect to the total amount of the organic pigments contained in the undercoat layer.

Binder Resin

Examples of the binder resin include polyurethane, a polyvinyl alcohol resin, a polyvinyl acetal resin, a casein resin, a polyamide resin, a cellulose resin, gelatin, a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin, a phenol-formaldehyde resin, a melamine resin, an alkyd resin, and an epoxy resin. The binder resin may be used alone or in combination of two or more kinds thereof.

As the binder resin of the undercoat layer, for example, polyurethane is preferable.

The binder resin of the undercoat layer contains, for example, preferably 80% by mass or greater of polyurethane, more preferably 90% by mass or greater of polyurethane, still more preferably 95% by mass or greater of polyurethane, and particularly preferably 100% by mass of polyurethane with respect to the total amount of the binder resin.

Polyurethane

Polyurethane is typically synthesized by a polyaddition reaction between a polyfunctional isocyanate and a polyol.

Examples of the polyfunctional isocyanate include a diisocyanate such as methylene diisocyanate, ethylene diisocyanate, isophorone diisocyanate, hexamethylene diisocyanate, 1,4-cyclohexane diisocyanate, 2,4-toluene diisocyanate, 2,6-toluene diisocyanate, 1,3-xylylene diisocyanate, 1,5-naphthalene diisocyanate, m-phenylene diisocyanate, p-phenylene diisocyanate, 3,3′-dimethyl-4,4′-diphenylmethane diisocyanate, 3,3′-dimethylbiphenylene diisocyanate, 4,4′-biphenylene diisocyanate, dicyclohexylmethane diisocyanate, or methylenebis(4-cyclohexyl isocyanate); an isocyanurate obtained by trimerizing the diisocyanate; and a blocked isocyanate in which the isocyanate group of the diisocyanate is blocked with a blocking agent. The polyfunctional isocyanate may be used alone or in combination of two or more kinds thereof.

Examples of the polyol include diols such as ethylene glycol, 1,2-propanediol, 1,3-propanediol, 1,2-butanediol, 1,3-butanediol, 2,3-butanediol, 2,2-dimethyl-1,3-propanediol, 1,2-pentanediol, 1,4-pentanediol, 1,5-pentanediol, 2,4-pentanediol, 3,3-dimethyl-1,2-butanediol, 2-ethyl-2-methyl-1,3-propanediol, 1,2-hexanediol, 1,5-hexanediol, 1,6-hexanediol, 2,5-hexanediol, 2-methyl-2,4-pentanediol, 2,2-diethyl-1,3-propanediol, 2,4-dimethyl-2,4-pentanediol, 1,7-heptanediol, 2-methyl-2-propyl-1,3-propanediol, 2,5-dimethyl-2,5-hexanediol, 2-ethyl-1,3-hexanediol, 1,2-octanediol, 1,8-octanediol, 2,2,4-trimethyl-1,3-pentanediol, 1,4-cyclohexanedimethanol, hydroquinone, diethylene glycol, triethylene glycol, dipropylene glycol, tripropylene glycol, polyethylene glycol, polypropylene glycol, poly(oxytetramethylene) glycol, 4,4′-dihydroxy-diphenyl-2,2-propane, and 4,4′-dihydroxyphenylsulfone.

Examples of the polyol further include polyester polyol, polycarbonate polyol, polycaprolactone polyol, polyether polyol, and polyvinyl butyral.

The polyol may be used alone or in combination of two or more kinds thereof.

The undercoat layer may contain inorganic particles.

Examples of the inorganic particles include inorganic particles having a powder resistance (volume resistivity) of 1×10² Ωcm or greater and 1×10¹¹ Ωcm or less.

Examples of the inorganic particles having the above-described resistance value include metal oxide particles such as tin oxide particles, titanium oxide particles, zinc oxide particles, and zirconium oxide particles. Among these, zinc oxide particles are preferable.

The specific surface area of the inorganic particles measured by the BET method may be, for example, 10 m²/g or greater.

The volume average particle diameter of the inorganic particles may be, for example, 50 nm or greater and 2,000 nm or less (for example, preferably 60 nm or greater and 1,000 nm or less).

The inorganic particles may be subjected to a surface treatment. The inorganic particles may be used by mixing two or more kinds of particles subjected to different surface treatments or two or more kinds of particles having different particle diameters.

Examples of the surface treatment agent include a silane coupling agent, a titanate-based coupling agent, an aluminum-based coupling agent, and a surfactant. For example, a silane coupling agent is preferable, and a silane coupling agent containing an amino group is more preferable.

Examples of the silane coupling agent containing an amino group include 3-aminopropyltri ethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltri ethoxy silane, and 3-chloropropyltrimethoxysilane, but are not limited thereto.

The surface treatment method using a surface treatment agent may be any method as long as the method is a known method, and any of a dry method or a wet method may be used. The treatment amount of the surface treatment agent is, for example, preferably 0.5% by mass or greater and 10% by mass or less with respect to the amount of the inorganic particles.

The undercoat layer may contain various additives for improving the electrical properties, the environmental stability, and the image quality. Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of a dispersing method of dispersing an organic pigment in a solvent include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

The average layer thickness of the undercoat layer is, for example, preferably 1 μm or greater and 15 μm or less, more preferably 2 μm or greater and 10 μm or less, and still more preferably 3 μm or greater and 8 μm or less.

Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 1×10¹³ Ωcm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. In a case where incoherent light is used as a light source, roughening of the surface to prevent interference fringes is not particularly necessary, and it is appropriate for longer life because occurrence of defects due to the unevenness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the fine pores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by immersing the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

Interlayer

An interlayer may be further provided between the undercoat layer and the photosensitive layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical coating methods such as a dip coating method, a push-up coating method, a wire bar coating method, a spray coating method, a blade coating method, a knife coating method, and a curtain coating method.

The average layer thickness of the interlayer is, for example, preferably 0.1 μm or greater and 3 μm or less. The interlayer may be used as the undercoat layer.

Charge Generation Layer

The charge generation layer is, for example, a layer containing a charge generation material and a binder resin. Further, the charge generation layer may be a deposition layer of the charge generation material. The deposition layer of the charge generation material is, for example, appropriate in a case where an incoherent light source such as a light emitting diode (LED) or an organic electro-luminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine, chlorogallium phthalocyanine, dichloro-tin phthalocyanine, and titanyl phthalocyanine are more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used, but from the viewpoint of the resolution, the field intensity in the photosensitive layer is increased, and a decrease in charge due to injection of a charge from the substrate, that is, image defects referred to as so-called black spots are likely to occur in a case where a thin film having a thickness of 20 μm or less is used as the photosensitive layer. The above-described tendency is evident in a case where a p-type semiconductor such as trigonal selenium or a phthalocyanine pigment is used as the charge generation material that is likely to generate a dark current.

On the other hand, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 1×10¹³ Ωcm or greater.

These binder resins may be used alone or in the form of a mixture of two or more kinds thereof.

The blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. The charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type homogenizer in which a dispersion liquid is dispersed by a liquid-liquid collision or a liquid-wall collision in a high-pressure state, and a penetration type homogenizer in which a dispersion liquid is dispersed by penetrating the liquid through a fine flow path in a high-pressure state.

During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The average layer thickness of the charge generation layer is, for example, preferably 0.1 μm or greater and 5.0 μm or less and more preferably 0.2 μm or greater and 2.0 μm or less.

Charge Transport Layer

The charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

From the viewpoint of the charge mobility, for example, a triarylamine derivative represented by Structural Formula (a-1) or a benzidine derivative represented by Structural Formula (a-2) is preferable as the charge transport material.

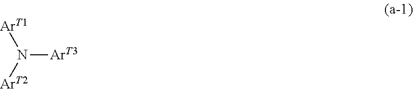

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

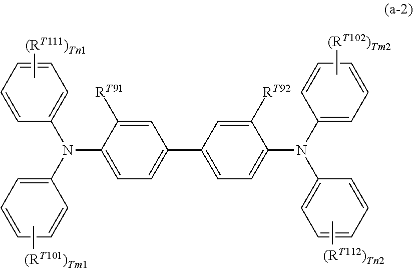

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, a substituted amino group substituted with an alkyl group having 1 or more and 2 or less carbon atoms, a substituted or unsubstituted aryl group, —C(R^{T12})═C(R^{T13})(R^{T14}), or —CH═CH—CH═C(R^{T15})(R^{T16}), and R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or greater and 2 or less.

Examples of the substituent of each group described above include a halogen atom, an alkyl group having 1 or more and 5 or less carbon atoms, and an alkoxy group having 1 or more and 5 or less carbon atoms. Further, examples of the substituent of each group described above include a substituted amino group substituted with an alkyl group having 1 or more and 3 or less carbon atoms.

Among the triarylamine derivative represented by Structural Formula (a-1) and the benzidine derivative represented by Structural Formula (a-2), a triarylamine derivative having “—C₆H₄—CH═CH—CH═C(R^{T7})(R^{T8})” and a benzidine derivative having “—CH═CH—CH═C(R^{T15})(R^{T16})” are preferable, for example, from the viewpoint of the charge mobility.

Examples of the polymer charge transport material include known compounds having charge transport properties, such as poly-N-vinylcarbazole and polysilane. For example, a polyester-based polymer charge transport material is preferable. The polymer charge transport material may be used alone or in combination with a binder resin.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among these, for example, a polycarbonate resin or a polyarylate resin is preferable as the binder resin. These binder resins may be used alone or in combination of two or more kinds thereof. The blending ratio between the charge transport material and the binder resin is, for example, preferably 10:1 to 1:5 in terms of the mass ratio.

The charge transport layer may also contain other known additives.

The formation of the charge transport layer is not particularly limited, and a known forming method is used. For example, a coating film of a coating solution for forming a charge transport layer in which the above-described components are added to a solvent is formed, and the coating film is dried and, as necessary, heated.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

The average layer thickness of the charge transport layer is, for example, preferably 5 μm or greater and 50 μm or less and more preferably 10 μm or greater and 30 μm or less.

Protective Layer

A protective layer is provided on the photosensitive layer as necessary. The protective layer is provided, for example, for the purpose of preventing a chemical change in the photosensitive layer during charging and further improving the mechanical strength of the photosensitive layer.

Therefore, for example, a layer formed of a cured film (crosslinked film) may be applied to the protective layer. Examples of these layers include the layers described in the items 1) and 2) below.
1) A layer formed of a cured film of a composition containing a reactive group-containing charge transport material having a reactive group and a charge-transporting skeleton in an identical molecule (that is, a layer containing a polymer or a crosslinked body of the reactive group-containing charge transport material)
2) A layer formed of a cured film of a composition containing a non-reactive charge transport material and a reactive group-containing non-charge transport material containing a reactive group without having a charge-transporting skeleton (that is, a layer containing the non-reactive charge transport material and a polymer or crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization and is, for example, a functional group containing a group having at least a carbon double bond. Specific examples thereof include a vinyl group, a vinyl ether group, a vinyl thioether group, a phenyl vinyl group, a vinyl phenyl group, an acryloyl group, a methacryloyl group, and a group containing at least one selected from derivatives thereof. Among these, from the viewpoint that the reactivity is excellent, for example, a vinyl group, a phenylvinyl group, a vinylphenyl group, an acryloyl group, a methacryloyl group, and a group containing at least one selected from derivatives thereof are preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, or a hydrazone-based compound. Among these, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

The protective layer may also contain other known additives.

The formation of the protective layer is not particularly limited, and a known forming method is used. For example, a coating film of a coating solution for forming a protective layer in which the above-described components are added to a solvent is formed, and the coating film is dried and, as necessary, subjected to a curing treatment such as heating.

Examples of the solvent for preparing the coating solution for forming a protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents are used alone or in the form of a mixture of two or more kinds thereof.

The coating solution for forming a protective layer may be a solvent-less coating solution.

Examples of the method of coating the photosensitive layer (such as the charge transport layer) with the coating solution for forming a protective layer include typical coating methods such as a dip coating method, a push-up coating method, a wire bar coating method, a spray coating method, a blade coating method, a knife coating method, and a curtain coating method.

The average layer thickness of the protective layer is, for example, preferably 1 μm or greater and 20 μm or less and more preferably 2 μm or greater and 10 μm or less.

Single Layer Type Photosensitive Layer

The single layer type photosensitive layer (charge generation/charge transport layer) is a layer containing a charge generation material, a charge transport material, a binder resin, and as necessary, other additives. These materials are the same as the materials described in the sections of the charge generation layer and the charge transport layer.

The content of the charge generation material in the single layer type photosensitive layer may be, for example, 0.1% by mass or greater and 10% by mass or less and preferably 0.8% by mass or greater and 5% by mass or less with respect to the total solid content.

The content of the charge transport material contained in the single layer type photosensitive layer may be, for example, 5% by mass or greater and 50% by mass or less with respect to the total solid content.

The method of forming the single layer type photosensitive layer is the same as the method of forming the charge generation layer or the charge transport layer.

The average layer thickness of the single layer type photosensitive layer is, for example, preferably 5 μm or greater and 50 μm or less and more preferably 10 μm or greater and 40 μm or less.

Image Forming Apparatus and Process Cartridge

An image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. Further, the electrophotographic photoreceptor according to the present exemplary embodiment is employed as the electrophotographic photoreceptor.

As the image forming apparatus according to the present exemplary embodiment, a known image forming apparatus such as an apparatus including a fixing device that fixes the toner image transferred to the surface of a recording medium; a direct transfer type apparatus that transfers the toner image formed on the surface of the electrophotographic photoreceptor directly to the recording medium; an intermediate transfer type apparatus that primarily transfers the toner image formed on the surface of the electrophotographic photoreceptor to the surface of the intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a destaticizing device that destaticizes the surface of the electrophotographic photoreceptor by irradiating the surface with destaticizing light after the transfer of the toner image and before the charging; or an apparatus including an electrophotographic photoreceptor heating member for increasing the temperature of the electrophotographic photoreceptor and decreasing the relative temperature is employed.

In a case of the intermediate transfer type device, the transfer unit is, for example, configured to include an intermediate transfer member having a surface onto which the toner image is transferred, a primary transfer device primarily transferring the toner image formed on the surface of the electrophotographic photoreceptor to the surface of the intermediate transfer member, and a secondary transfer device secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

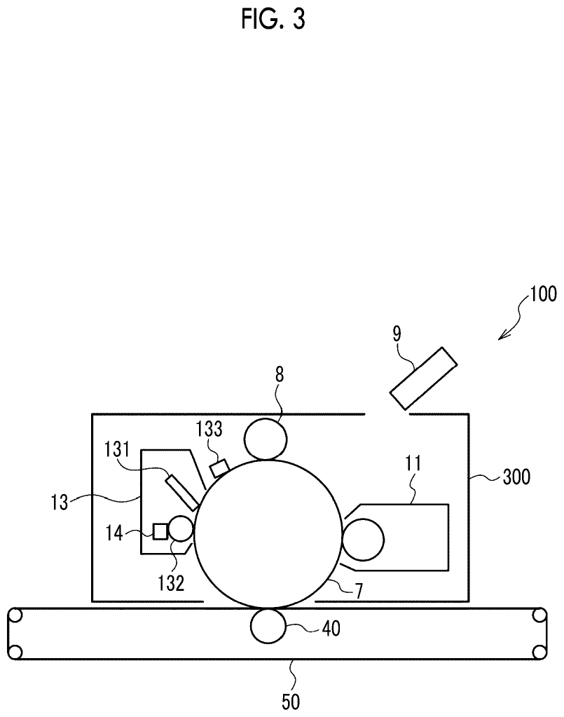

FIG. 3 is a schematic configuration view showing an example of an image forming apparatus according to the present exemplary embodiment.

As shown in FIG. 3, an image forming apparatus 100 according to the present exemplary embodiment includes a process cartridge 300 including an electrophotographic photoreceptor 7, an exposure device 9 (an example of an electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 3 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of the cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 3 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

Charging Device

As the charging device 8, for example, a contact-type charger formed of a conductive or semi-conductive charging roller, a charging brush, a charging film, a charging rubber blade, a charging tube, or the like is used. Further, known chargers such as a non-contact type roller charger, a scorotron charger using corona discharge, and a corotron charger are also used.

Examples of the exemplary embodiment of the charging device 8 include an AC/DC charging type charging device that charges the surface of the photoreceptor by superimposing an alternating current voltage on a direct current voltage and applying the voltage.

It is preferable that the charging member included in the AC/DC charging type charging device is, for example, a contact type charging member that comes into contact with the surface of the photoreceptor to charge the photoreceptor. The shape of the charging member is, for example, a roll shape, a belt shape, or a blade shape.

Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength of approximately 600 nm or a laser having an oscillation wavelength of 400 nm or greater and 450 nm or less as a blue laser may also be used. Further, a surface emission type laser light source capable of outputting a multi-beam is also effective for forming a color image.

Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

Cleaning Device

As the cleaning device 13, a cleaning blade type device including the cleaning blade 131 is used. In addition to the cleaning blade type device, a fur brush cleaning type device or a simultaneous development cleaning type device may be employed.

Transfer Device

Examples of the transfer device 40 include transfer chargers known per se, for example, a contact-type transfer charger formed of a belt, a roller, a film, and a rubber blade, a scorotron transfer charger using corona discharge, and a corotron transfer charger.

Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

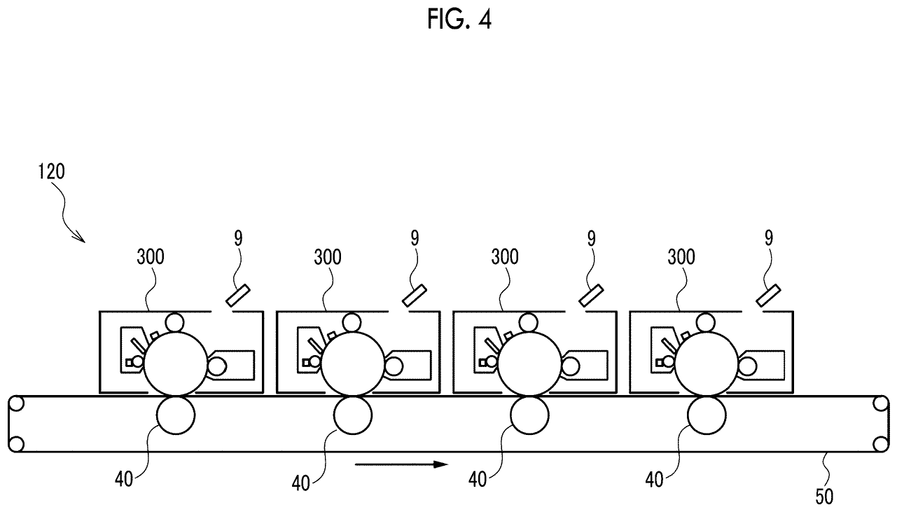

FIG. 4 is a schematic configuration view showing an example of an image forming apparatus according to the present exemplary embodiment.

An image forming apparatus 120 shown in FIG. 4 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. The image forming apparatus 120 has the same configuration as the image forming apparatus 100 except that the image forming apparatus 120 is of a tandem type.

### EXAMPLES

Hereinafter, exemplary embodiments of the invention will be described in detail based on examples, but the exemplary embodiments of the invention are not limited to the examples.

In the following description, the preparation, the treatment, the production, and the like are carried out at room temperature (25° C.±3° C.) unless otherwise specified.

Production of Photoreceptor

### Example 1

Formation of Undercoat Layer

A perinone compound (1-1) is prepared as an organic pigment. The perinone compound (1-1) is pulverized with zirconia beads having a diameter of 0.3 mm in a planetary ball mill (P-7 Classic Line, manufactured by Fritsch Japan Co., Ltd.) for 5 hours.

20 parts by mass of a blocked isocyanate (SUMIDUR BL3175, manufactured by Sumitomo Bayer Urethane Co., Ltd., solid content of 75% by mass) and 7.5 parts by mass of butyral resin (S-LEC BL-1, manufactured by Sekisui Chemical Co., Ltd.) are dissolved in 150 parts by mass of methyl ethyl ketone. 37 parts by mass of the perinone compound (1-1) is mixed with the solution and dispersed with a sand mill using glass beads having a diameter of 1 mm for 10 hours, thereby obtaining a dispersion liquid. 0.005 parts by mass of dioctyltin dilaurate as a catalyst and 2 parts by mass of silicone resin particles (trade name: TOSPEARL 145, manufactured by Momentive Performance Materials Inc.) are added to the dispersion liquid. The solution is filtered using a pressure filter to remove aggregates, thereby obtaining a coating solution for forming an undercoat layer.

A cylindrical aluminum base material is immersed in and coated with the coating solution and dried and cured at 160° C. for 60 minutes to form an undercoat layer having a thickness of 3 μm and containing polyurethane as a binder resin.

Formation of Charge Generation Layer

Hydroxygallium phthalocyanine having diffraction peaks at least at positions where Bragg angles (2θ±0.2°) of the X-ray diffraction spectrum using Cuka characteristic X-ray are 7.3°, 16.0°, 24.9°, and 28.0° is prepared as the charge generation material. A mixture obtained by mixing 15 parts by mass of the hydroxygallium phthalocyanine, 10 parts by mass of a vinyl chloride-vinyl acetate copolymer resin (VMCH, Nippon Unicar Company Limited), and 200 parts by mass of n-butyl acetate is dispersed in a sand mill using glass beads having a diameter of 1 mm for 4 hours. 175 parts by mass of n-butyl acetate and 180 parts by mass of methyl ethyl ketone are added to the dispersion liquid, and the mixture is stirred, thereby obtaining a coating solution for forming a charge generation layer. The undercoat layer is immersed in and coated with the coating solution and dried at 150° C. for 15 minutes, thereby forming a charge generation layer having a thickness of 0.2

Formation of Charge Transport Layer

38 parts by mass of a charge transport agent (HT-1), 10 parts by mass of a charge transport agent (HT-2), and 52 parts by mass of a polycarbonate (A) (viscosity average molecular weight of 46,000) are added to 800 parts by mass of tetrahydrofuran and dissolved therein, and 8 parts by mass of a polytetrafluoroethylene resin (LUBRON L5, manufactured by Daikin Industries, Ltd., average particle diameter of 300 nm) is added thereto and dispersed at 5,500 rpm using a homogenizer (ULTRA-TURRAX, manufactured by IKA) for 2 hours, thereby obtaining a coating solution for forming a charge transport layer. The charge generation layer is immersed in and coated with the coating solution and dried at 140° C. for 40 minutes, thereby forming a charge transport layer having a thickness of 29 μm. A photoreceptor of Example 1 is obtained by performing the above-described treatment.

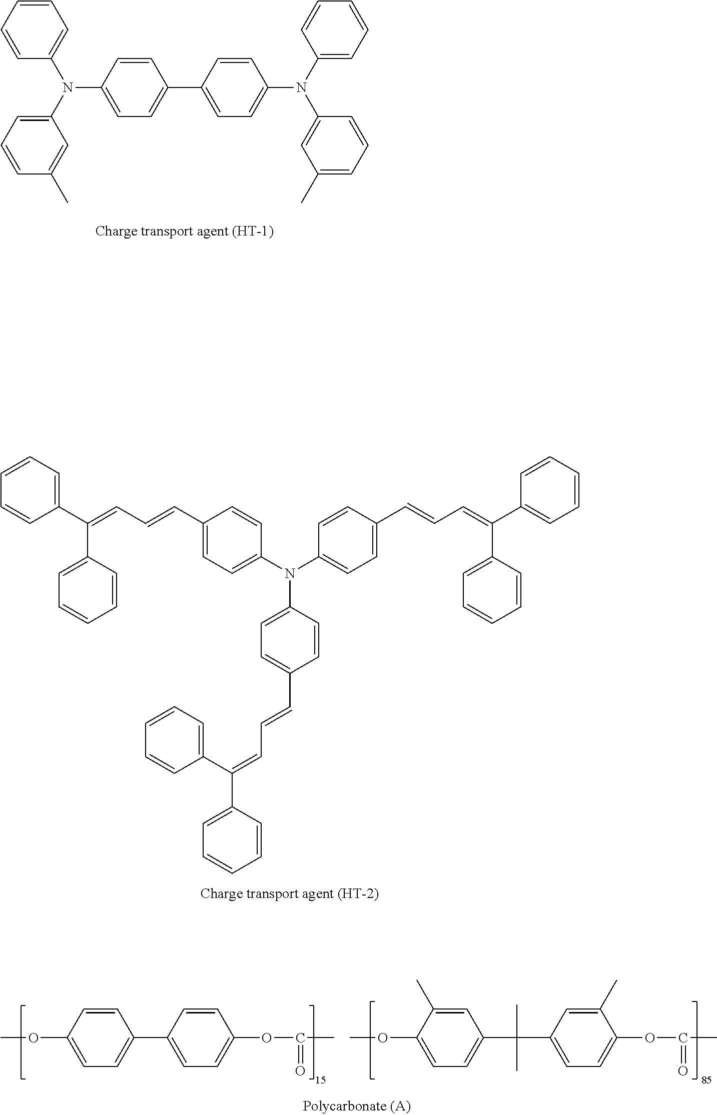

### Example 2

A photoreceptor is produced in the same manner as in Example 1 except that the kind and the mass proportion of the organic pigment are changed as listed in Table 1 and the thickness of the undercoat layer is changed as listed in Table 1 in the formation of the undercoat layer.

### Example 3

A photoreceptor is produced in the same manner as in Example 1 except that the kind and the mass proportion of the organic pigment are changed as listed in Table 1, the time for the dispersion treatment using a sand mill is changed to 12 hours, and the thickness of the undercoat layer is changed as listed in Table 1 in the formation of the undercoat layer.

### Example 4

A photoreceptor is produced in the same manner as in Example 1 except that the kind and the mass proportion of the organic pigment are changed as listed in Table 1, the time for the dispersion treatment using a sand mill is changed to 15 hours, and the thickness of the undercoat layer is changed as listed in Table 1 in the formation of the undercoat layer.

### Example 5

A photoreceptor is produced in the same manner as in Example 1 except that the kind and the mass proportion of the organic pigment are changed as listed in Table 1, the time for the dispersion treatment using a sand mill is changed to 18 hours, and the thickness of the undercoat layer is changed as listed in Table 1 in the formation of the undercoat layer.

### Example 6

A photoreceptor is produced in the same manner as in Example 1 except that the kind and the mass proportion of the organic pigment are changed as listed in Table 1, the time for the dispersion treatment using a sand mill is changed to 8 hours, and the thickness of the undercoat layer is changed as listed in Table 1 in the formation of the undercoat layer.

### Example 7

A photoreceptor is produced in the same manner as in Example 1 except that the kind and the mass proportion of the organic pigment are changed as listed in Table 1, the time for the dispersion treatment using a sand mill is changed to 15 hours, and the thickness of the undercoat layer is changed as listed in Table 1 in the formation of the undercoat layer.

### Example 8

A photoreceptor is produced in the same manner as in Example 1 except that the kind and the mass proportion of the organic pigment are changed as listed in Table 1 and the time for the dispersion treatment using a sand mill is changed to 14 hours in the formation of the undercoat layer.

### Example 9

A photoreceptor is produced in the same manner as in Example 1 except that the kind and the mass proportion of the organic pigment are changed as listed in Table 1, the time for the dispersion treatment using a sand mill is changed to 16 hours, and the thickness of the undercoat layer is changed as listed in Table 1 in the formation of the undercoat layer.

The structures of the naphthalenediimide compound (A), the naphthalenediimide compound (B), and the naphthalenediimide compound (C) used in Examples 7 to 9 are shown below.

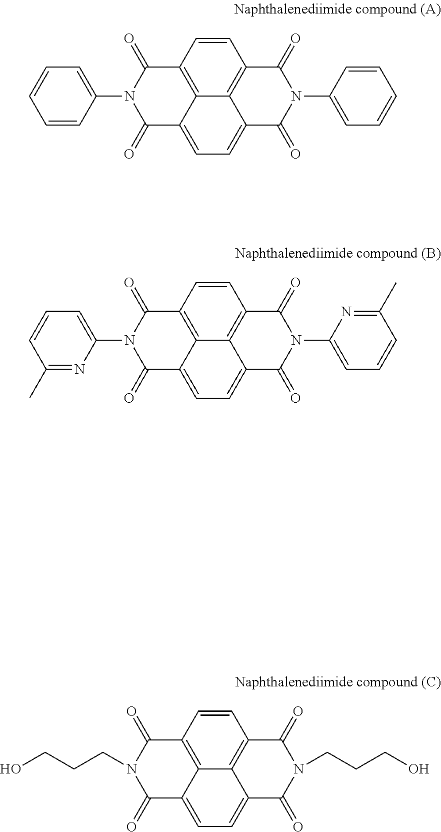 [SMILES: O=C1c2ccc3c4c(ccc(c24)C(=O)N1c1ccccc1)C(=O)N(c1ccccc1)C3=O ; Cc1cccc(N2C(=O)c3ccc4c5c(ccc(c35)C2=O)C(=O)N(c2cccc(C)n2)C4=O)n1 ; O=C1c2ccc3c4c(ccc(c24)C(=O)N1CCCO)C(=O)N(CCCO)C3=O]

### Comparative Example 1

A photoreceptor is produced in the same manner as in Example 1 except that the time for the dispersion treatment using a sand mill is changed to 2 hours and the thickness of the undercoat layer is changed as listed in Table 1 without performing pressure filtration of the solution in the formation of the undercoat layer.

### Comparative Example 2

A photoreceptor is produced in the same manner as in Example 1 except that the kind and the mass proportion of the organic pigment are changed as listed in Table 1, the time for the dispersion treatment using a sand mill is changed to 5 hours without performing a pulverization treatment on the organic pigment using a planetary ball mill, and the thickness of the undercoat layer is changed as listed in Table 1 without performing pressure filtration of the solution in the formation of the undercoat layer.

### Comparative Example 3

A photoreceptor is produced in the same manner as in Example 1 except that the kind and the mass proportion of the organic pigment are changed as listed in Table 1 and the thickness of the undercoat layer is changed as listed in Table 1 without performing a pulverization treatment on the organic pigment using a planetary ball mill and without performing pressure filtration of the solution in the formation of the undercoat layer.

### Comparative Example 4

A photoreceptor is produced in the same manner as in Example 1 except that the kind and the mass proportion of the organic pigment are changed as listed in Table 1, the time for the dispersion treatment using a sand mill is changed to 5 hours without performing a pulverization treatment on the organic pigment using a planetary ball mill, and the thickness of the undercoat layer is changed as listed in Table 1 without performing pressure filtration of the solution in the formation of the undercoat layer.

Performance Evaluation of Photoreceptor

Electrical Characteristics

The obtained photoreceptor is installed in a laser printer modified scanner (XP-15 modified machine, manufactured by FUJIFILM Business Innovation Corp.). The surface potential of the photoreceptor is measured while the following steps (1) to (3) are performed with the laser printer modified scanner in an environment of a temperature of 20° C. and a relative humidity of 40%.
(1) The photoreceptor is charged using a scorotron charger having a grid applied voltage of −700 V.
(2) The photoreceptor is irradiated with light at 10.0 erg/cm 2 using a semiconductor laser having a wavelength of 780 nm one second after the charging, and discharged.
(3) The photoreceptor is irradiated with red LED light at 50.0 erg/cm 2 three seconds after the irradiation with light, and destaticized.

Photosensitivity

The surface potential of the photoreceptor after the step (2) is classified as follows. For example, the photosensitivity is desirable as the surface potential is closer to 0 V.
A: −240 V or greater
B: −280 V or greater and less than −240 V
C: −300 V or greater and less than −280 V
D: Less than −300 V

Residual Potential

The surface potential of the photoreceptor after the step (3) is classified as follows. For example, the residual potential is desirable as the surface potential is closer to 0 V.
A: −20 V or greater
B: −40 V or greater and less than −20 V
C: −80 V or greater and less than −40 V
D: Less than −80 V

Spot-Like Image Defects

The photoreceptor is mounted in an image forming apparatus (DocuCentre-IV C2270, manufactured by FUJIFILM Business Innovation Corp.).

Columnar carbon fibers (diameter of 10 μm, length of 70 μm) are intentionally added to a black toner cartridge container of the image forming apparatus by assuming that conductive needle-like foreign matter is generated from a deteriorated developing unit or transfer unit with long-term use of the image forming apparatus and the foreign matter is stuck into the surface of the photoreceptor. The amount of carbon fibers added is 300 mg with respect to 100 g of the toner.

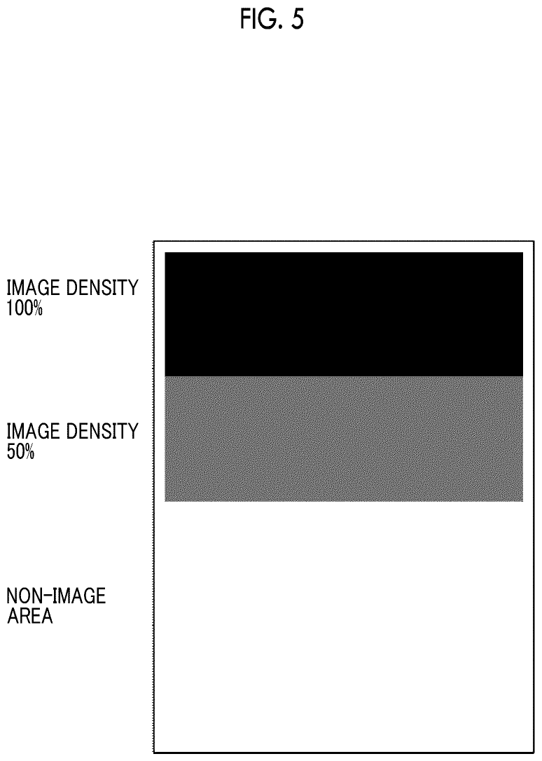

100 sheets of the chart shown in FIG. 5 (a black image with a density of 100% and a width of 100 mm and a black image with a density of 50% with a width of 100 mm in order from the upstream in the transport direction) are output on A3 size plain paper using the above-described image forming apparatus in an environment of a temperature of 20° and a relative humidity of 40%.

The surface on which the 100th image is formed is scanned with a scanner, binarization processing is performed using image processing software, and the number of black spots appearing in the non-image area is counted and classified as follows.
A: Less than 50 spots
B: 50 or more spots and less than 200 spots
C: 200 or more spots and less than 400 spots
D: 400 or more spots

TABLE 1

| | Undercoat layer | | | | | | | |
|---|---|---|---|---|---|---|---|---|
| | Organic pigment | | | | | | | |
| | | Mass | | | | | | |
| | | proportion | | | | Performance of photoreceptor | | |
| | | in | | | | | | Spot- |
| | | undercoat | Average | | | | | like |
| | | layer | layer | εr | tan δ | | Residual | image |
| | Type | % by | thickness | (Max) | (Max) | Photosensitivity | potential | defects |
| | — | mass | μm | — | — | — | — | — |
| Example 1 | Perinone compound | 60 | 3 | 4.9 | 0.2 | A | A | A |
| | (1-1) | | | | | | | |
| Example 2 | Perinone compound | 70 | 5 | 4.5 | 0.3 | A | A | A |
| | (1-3) | | | | | | | |
| Example 3 | Perinone compound | 50 | 5 | 4.2 | 0.2 | B | B | A |
| | (1-6) | | | | | | | |
| Example 4 | Perinone compound | 60 | 10 | 4.8 | 0.08 | A | B | A |
| | (2-1) | | | | | | | |
| Example 5 | Perinone compound | 70 | 10 | 5.0 | 0.1 | A | B | A |
| | (2-3) | | | | | | | |
| Example 6 | Perinone compound | 60 | 2 | 4.0 | 0.4 | A | A | B |
| | (2-8) | | | | | | | |
| Example 7 | Naphthalenediimide | 70 | 7 | 5.5 | 0.4 | B | B | B |
| | compound (A) | | | | | | | |
| Example 8 | Naphthalenediimide | 65 | 3 | 5.8 | 0.45 | B | B | B |
| | compound (B) | | | | | | | |
| Example 9 | Naphthalenediimide | 70 | 5 | 6.3 | 0.4 | B | B | B |
| | compound (C) | | | | | | | |
| Comparative | Perinone compound | 60 | 10 | 5.5 | 0.8 | C | C | C |
| Example 1 | (1-1) | | | | | | | |
| Comparative | Naphthalenediimide | 60 | 12 | 9.0 | 0.9 | D | D | D |
| Example 2 | compound (A) | | | | | | | |
| Comparative | Naphthalenediimide | 60 | 5 | 6.4 | 0.6 | D | D | C |
| Example 3 | compound (B) | | | | | | | |
| Comparative | Naphthalenediimide | 60 | 5 | 7.0 | 0.8 | D | D | D |
| Example 4 | compound (C) | | | | | | | |

(((1)))

An electrophotographic photoreceptor comprising:
a conductive substrate;
an undercoat layer disposed on the conductive substrate; and
a photosensitive layer disposed on the undercoat layer,
wherein the undercoat layer contains an organic pigment and a binder resin and satisfies Expressions (A1) and (B1),

εr(Max)≤7.0 Expression (A1)

tan δ(Max)≤0.5 Expression (B1)
εr (Max) represents a maximum value of a relative permittivity at a measurement frequency of 10 Hz to 3,000 Hz and tan δ(Max) represents a maximum value of a dielectric loss tangent at the measurement frequency of 10 Hz to 3,000 Hz, which are acquired by measuring an impedance of the undercoat layer at a temperature of 22° C. and a relative humidity of 50%.
(((2)))

The electrophotographic photoreceptor according to (((1))), wherein the undercoat layer satisfies Expressions (A2) and (B2),

εr(Max)≤5.5 Expression (A2)

tan δ(Max)≤0.4 Expression (B2)
εr (Max) represents a maximum value of a relative permittivity at a measurement frequency of 10 Hz to 3,000 Hz and tan δ(Max) represents a maximum value of a dielectric loss tangent at the measurement frequency of 10 Hz to 3,000 Hz, which are acquired by measuring an impedance of the undercoat layer at a temperature of 22° C. and a relative humidity of 50%.
(((3)))

The electrophotographic photoreceptor according to (((1))) or (((2))),
wherein a proportion of a total amount of the organic pigment in a total amount of the undercoat layer is 50% by mass or greater and 70% by mass or less.
(((4)))

The electrophotographic photoreceptor according to any one of (((1))) to (((3))),
wherein the organic pigment contains at least one selected from the group consisting of a perinone compound and a naphthalenediimide compound.
(((5)))

The electrophotographic photoreceptor according to any one of (((1))) to (((3))),
wherein the organic pigment contains at least one perinone compound selected from the group consisting of a compound represented by Formula (1) and a compound represented by Formula (2).
(((6)))

The electrophotographic photoreceptor according to (((5))),
wherein a proportion of a total amount of the perinone compound in a total amount of the undercoat layer is 50% by mass or greater and 70% by mass or less.
(((7)))

The electrophotographic photoreceptor according to any one of (((1))) to (((6))), wherein the undercoat layer has an average layer thickness of 2 μm or greater and 10 μm or less.
(((8)))

The electrophotographic photoreceptor according to any one of (((1))) to (((7))),
wherein the binder resin contains polyurethane.
(((9)))

A process cartridge comprising:
the electrophotographic photoreceptor according to any one of (((1))) to (((8))),
wherein the process cartridge is attachable to and detachable from an image forming apparatus.
(((10)))

An image forming apparatus comprising:
the electrophotographic photoreceptor according to any one of (((1))) to (((8)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
(((11)))

The image forming apparatus according to (((10))),
wherein the charging device is a charging device that charges the surface of the electrophotographic photoreceptor by superimposing an alternating current voltage on a direct current voltage and applying the voltage.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
an undercoat layer disposed on the conductive substrate; and
a photosensitive layer disposed on the undercoat layer,
wherein the undercoat layer contains an organic pigment and a binder resin and satisfies Expressions (A1) and (B1),
εr(Max)≤7.0 Expression (A1)
tan δ(Max)≤0.5 Expression (B1)
εr (Max) represents a maximum value of a relative permittivity at a measurement frequency of 10 Hz to 3,000 Hz and tan δ(Max) represents a maximum value of a dielectric loss tangent at the measurement frequency of 10 Hz to 3,000 Hz, which are acquired by measuring an impedance of the undercoat layer at a temperature of 22° C. and a relative humidity of 50%.

2. The electrophotographic photoreceptor according to claim 1,
wherein the undercoat layer satisfies Expressions (A2) and (B2),
εr(Max)≤5.5 Expression (A2)
tan δ(Max)≤0.4 Expression (B2)
εr (Max) represents a maximum value of a relative permittivity at a measurement frequency of 10 Hz to 3,000 Hz and tan δ(Max) represents a maximum value of a dielectric loss tangent at the measurement frequency of 10 Hz to 3,000 Hz, which are acquired by measuring an impedance of the undercoat layer at a temperature of 22° C. and a relative humidity of 50%.

3. The electrophotographic photoreceptor according to claim 1,
wherein a proportion of a total amount of the organic pigment in a total amount of the undercoat layer is 50% by mass or greater and 70% by mass or less.

4. The electrophotographic photoreceptor according to claim 1,
wherein the organic pigment contains at least one selected from the group consisting of a perinone compound and a naphthalenediimide compound.

5. The electrophotographic photoreceptor according to claim 1,
wherein the organic pigment contains at least one perinone compound selected from the group consisting of a compound represented by Formula (1) and a compound represented by Formula (2), 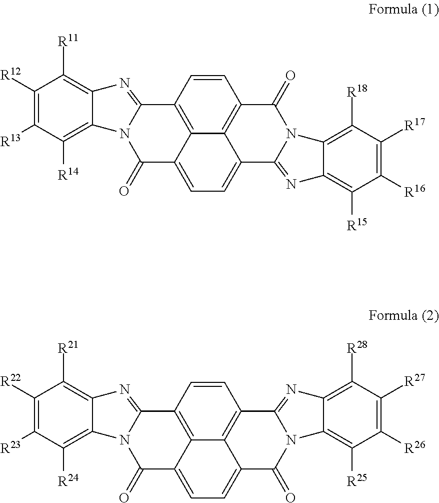
in Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, and R¹³ and R¹⁴ may be each independently linked to each other to form a ring, and R¹⁵ and R¹⁶, R¹⁶ and R¹⁷, and R¹⁷ and R¹⁸ may be each independently linked to each other to form a ring,
in Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, and R²³ and R²⁴ may be each independently linked to each other to form a ring, and R²⁵ and R²⁶, R²⁶ and R²⁷, and R²⁷ and R²⁸ may be each independently linked to each other to form a ring.

6. The electrophotographic photoreceptor according to claim 5,
wherein a proportion of a total amount of the perinone compound in a total amount of the undercoat layer is 50% by mass or greater and 70% by mass or less.

7. The electrophotographic photoreceptor according to claim 1,
wherein the undercoat layer has an average layer thickness of 2 μm or greater and 10 μm or less.

8. The electrophotographic photoreceptor according to claim 1,
wherein the binder resin contains polyurethane.

9. A process cartridge comprising:
the electrophotographic photoreceptor according to claim 1,
wherein the process cartridge is attachable to and detachable from an image forming apparatus.

10. A process cartridge comprising:
the electrophotographic photoreceptor according to claim 2,
wherein the process cartridge is attachable to and detachable from an image forming apparatus.

11. A process cartridge comprising:
the electrophotographic photoreceptor according to claim 3,
wherein the process cartridge is attachable to and detachable from an image forming apparatus.

12. A process cartridge comprising:
the electrophotographic photoreceptor according to claim 4,
wherein the process cartridge is attachable to and detachable from an image forming apparatus.

13. A process cartridge comprising:
the electrophotographic photoreceptor according to claim 5,
wherein the process cartridge is attachable to and detachable from an image forming apparatus.

14. A process cartridge comprising:
the electrophotographic photoreceptor according to claim 6,
wherein the process cartridge is attachable to and detachable from an image forming apparatus.

15. A process cartridge comprising:
the electrophotographic photoreceptor according to claim 7,
wherein the process cartridge is attachable to and detachable from an image forming apparatus.

16. A process cartridge comprising:
the electrophotographic photoreceptor according to claim 8,
wherein the process cartridge is attachable to and detachable from an image forming apparatus.

17. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

18. An image forming apparatus comprising:
the electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

19. An image forming apparatus comprising:
the electrophotographic photoreceptor according to claim 3;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

20. The image forming apparatus according to claim 17,
wherein the charging device is a charging device that charges the surface of the electrophotographic photoreceptor by superimposing an alternating current voltage on a direct current voltage and applying the voltage.
